(19) United States
(12) Patent Application Publication
(10) Pub. No.: US 2017/0032088 A1
(43) Pub. Date: Feb. 2, 2017

(54) Characterizing Healthcare Provider, Claim, Beneficiary and Healthcare Mercant Normal Behavior Using Non-Parametric Statistical Outlier Detection Scoring Techniques

(71) Applicant: Risk Management Solutions LLC, Maple Grove, MN (US)

(72) Inventors: Allen Jost, Coronado, CA (US); Rudolph John Freese, Greeley, CO (US); Walter Allan Klindworth, Maple Grove, MN (US)

(73) Assignee: Risk Management Solutions LLC, Maple Grove, MN (US)

(21) Appl. No.: 15/290,566

(22) Filed: Oct. 11, 2016

Related U.S. Application Data
(63) Continuation of application No. 13/617,085, filed on Sep. 14, 2012.
(60) Provisional application No. 61/561,561, filed on Nov. 18, 2011.

(51) Int. Cl. G06F 19/00

(52) U.S. Cl. CPC G06F 19/328; G06F 19/322

(57) ABSTRACT

This invention uses non-parametric statistical measures and probability mathematical techniques to calculate deviations of variable values, on both the high and low side of a data distribution, from the midpoint of the data distribution. It transforms the data values and then combines all of the individual variable values into a single scalar value that is a “good-ness” score. This “good-ness” behavior score model characterizes “normal” or typical behavior, rather than predicting fraudulent, abusive, or “bad”, behavior. The “good” score is a measure of how likely it is that the subject's behavior characteristics are from a population representing a “good” or “normal” provider, claim, beneficiary or healthcare merchant behavior. The “good” score can replace or compliment a score model that predicts “bad” behavior in order to reduce false positive rates. The optimal risk management prevention program should include both a “good” behavior score model and a “bad” behavior score model.

### CROSS-REFERENCE TO RELATED APPLICATIONS

This application is a continuation of application Ser. No. 13/617,085 filed Sep. 14, 2012 and incorporates the entire contents of each of the following patent applications, utility patent application 13/074576, filed Mar. 29, 2011; provisional patent application 61/319,554, filed Mar. 31, 2010, and provisional patent application 61/327,256, filed Apr. 23, 2010.

### STATEMENT REGARDING FEDERALLY SPONSORED RESEARCH

Not Applicable.

### FIELD OF THE INVENTION

The present invention is in the technical field of Healthcare Fraud, Abuse and Waste Prevention and Detection. More particularly, the present invention uses non-parametric statistics and probability methods to calculate a score that mathematically describes normal, typical, acceptable or “good” healthcare provider, claim, beneficiary or healthcare merchant traits and behavior. The invention is intended for use by government, public sector healthcare payers and private sector healthcare payers, as well as any healthcare intermediary. Healthcare intermediary is defined as any entity that accepts healthcare data or payment information and completes data aggregation or standardization, claims processing or program administration, applies rules or edits, stores data or offers data mining software, performs address or identity analysis or credentialing, offers case management or workflow management or performs investigations for fraud, abuse, waste or errors or any other entity which handles, evaluates, approves or submits claim payments through any means. The invention uses historical databases to develop a score that summarizes peer group performance and compares current provider, beneficiary, claim or healthcare merchant transactions to the typical performance of their respective peer group to identify healthcare providers, beneficiaries, claims or healthcare merchants that exhibit normal or typical behavior. The invention can be applied within a plurality of healthcare segments such as Hospital, Inpatient Facilities, Outpatient Institutions, Physician, Pharmaceutical, Skilled Nursing Facilities, Hospice, Home Health, Durable Medical Equipment and Laboratories. The invention is also applicable to a plurality of medical specialties, such as family practice, orthopedics, internal medicine and dermatology, for example. The invention can be deployed in diverse data format environments and in separate or a plurality of geographies, such as by zip code, county, metropolitan statistical area, state or healthcare processor region.

The invention's characterization models enable the collection and storage of legitimate historical healthcare data, such as claims data, that is tagged as normal, typical, good or acceptable as well as fraudulent, aberrant, incorrect, improper, wasteful, over-serviced, over-utilized and abusive, in order to validate the characterization score and to eventually provide a “feedback loop” to enable future weighted non-parametric based unsupervised models or parametric based “supervised” score model development. A supervised score model is here defined as a statistical score model that has a dependent variable and an unsupervised model is defined as a score model that does not have a dependent variable. The characterization score provides the probability, or likelihood, that any individual observation exhibits normal or typical behavior. Additionally, the characterization model outputs score reasons corresponding to why an observation scored as it did based on the specific variables with the highest probabilities of characterizing an observation as normal or typical. Once the characterization score model is developed on historical data, it is deployed in a production environment that scores current provider, beneficiary, claim or healthcare merchant transactions in order to estimate and rank the likelihood that the current transaction is “good”, “typical” or “normal”.

### BACKGROUND OF THE INVENTION

The present invention is in the technical field of Healthcare Fraud, Abuse and Waste Prevention and Detection. More particularly, the present invention is in the technical field of Healthcare Payment Fraud, Abuse and Waste Prevention and Detection where it pertains to provider, beneficiary or merchant healthcare claims and payments reviewed by government agencies, such as Medicare, Medicaid and TRICARE, as well as private commercial enterprises such as Private Insurance Companies, Third Party Administrators, Medical Claims Data Processors, Electronic Clearinghouses, and Claims Integrity Organizations that utilize edits or rules and Electronic Payment entities that process and pay claims to healthcare providers. More particularly, this invention pertains to identifying normal, typical, acceptable or “good” behavior by providers, beneficiaries or healthcare merchants in a plurality of healthcare segments, including:
1. Hospital
2. Inpatient Facilities
3. Outpatient Institutions
4. Physician
5. Pharmaceutical
6. Skilled Nursing Facilities
7. Hospice
8. Home Health
9. Durable Medical Equipment
10. Laboratories

Healthcare providers are here defined as those individuals, companies, entities or organizations that provide a plurality of healthcare services or products and submit claims for payment or financial gain in the healthcare industry segments listed in items 1-10 above. Healthcare beneficiaries are here defined as individuals who receive healthcare treatments, services or products from providers. Beneficiary is also commonly referred to as a “patient”. The beneficiary definition also includes individuals or entities posing as a patient, but are in fact not a legitimate patient and are therefore exploiting their role as a patient for personal or financial gain. Healthcare merchant is described as an entity or individual, not meeting the exact definition of a healthcare provider, but having the ability to offer services or products for financial gain to providers, beneficiaries or healthcare intermediaries through any channel, including, but not limited to retail store, pharmacy, clinic, hospital, internet or mail.

In particular, the present invention includes the description of provider related normal behavior, as well as individual medical claim, beneficiary or healthcare merchant normal behavior as a part of healthcare fraud, abuse and waste prevention and detection in the above referenced healthcare segments and markets. More particularly, the present invention uses non-parametric statistics and probability density methods to describe the characteristics of normal provider, beneficiary, claim or healthcare merchant behavior.

Existing fraud, abuse and waste prevention and detection analytical technology generally focuses on detecting or describing the behavior of “bad” or fraudulent, abusive or wasteful providers, beneficiaries, claims or healthcare merchants. However, there is much to be said in favor of describing the characteristics of a “good claim”, a “good provider”, a “good beneficiary” or a “good healthcare merchant”, rather than a constantly changing set of “bad guy” definitions or characteristics. In fact, the “good” behavior model is less complex to verify because it can be assumed a provider, beneficiary, claim or healthcare merchant is good until indicated bad, similar to statistical hypothesis-testing, where it is assumed a state of “NO Difference” exists unless “demonstrated” otherwise. In general, “typical”, “consistent” or “normal” behavior can be expected to occur at a far higher rate, rather than relatively smaller number of occurrences of rare, unstable and varied inconsistent or non-normal behavior. Normal behavior is more stable and predictable and there are a far larger number of typical or “good” providers, claims and beneficiaries to use in building the model.

The invention includes multi-dimensional capabilities that gauge the likelihood of normal patterns of behavior, including but not limited to, healthcare claims, providers, beneficiary (individual/patient) or healthcare merchant. The invention is a scoring model, which combines separate score model dimensions for claims behavior, provider behavior, beneficiary behavior and healthcare merchant behavior. Each dimension is a sub-model in itself, with further models created and segmented by additional dimensions, including but not limited to, provider specialty and geography, or patient or population illness burden or morbidity or disease state. Each sub-model provides a score, which summarizes the likelihood that either separately or combined, one or more of the dimensions has claim, provider or beneficiary characteristics with usual, normal or “good” behavior.

Fraudulent, abusive or wasteful perpetrators typically change and adapt their behavior to avoid new techniques that are constantly being developed to detect and thwart their illicit behavior. Fraudsters, for example, by their natures, are continually plotting and scheming to find ways to beat the system while remaining anonymous and unpredictable. When building the fraud prevention models it is difficult to a-priori design and build models that effectively describe or predict all the different forms of “bad” behavior, and so, by definition, the model builders would have to wait to discover them after the fact. Thus the fraudster behavior characteristics are often transient, inconsistent and difficult to identify, and define. Therefore, fraud models intended to describe this “bad” behavior, behavior that is constantly changing, is like trying to describe a moving target or elusive quarry. Particularly when “bad” has so many different definitions, such as fraud, abuse, waste, over-servicing, over-utilization or any number of data entry error types. Additionally, there are generally a very small number of examples of any one type of “bad” behavior because it is estimated that less than 10% of all claims, providers, beneficiaries or healthcare merchants are considered to be “bad”, while the majority, (90%) of providers, claims, beneficiaries or healthcare merchants are not fraudulent or abusive. This disparity means there is available a much larger set of data for describing “normal” or “good” behavior than is available to describe “bad” behavior. The larger pool of more homogeneous data for describing “good” behavior also means there is more likely to be statistical model stability. The optimal approach to understanding and preventing healthcare fraud, abuse and waste is to build both types of models, those that detect “bad guys” and those that describe the good behavior.

The “good” behavior invention is designed and based on the concept that the majority of the submissions are “normal” or “NOT Bad” claims, providers, beneficiaries or healthcare merchants similar to statistical hypothesis testing where it is assumed that there is “no statistical difference” until demonstrated otherwise. Variables are created with the objective of describing “good” behavior. Historical data is used for score model development. Then, new incoming observations are scored based upon the historical data score model data. Non-parametric and probability statistics and mathematical techniques are used to build the score models and to mathematically describe the data distributions and test them for consistency. Rather than giving more points, on a score type scale, for odd, unusual or “bad” behavior, these “good” score models assign the most points for behavior that is centered about the mid-point of the data distribution under the assumption that providers, claims, beneficiaries or healthcare merchants that are nearest to the “midpoint” value of other similar providers, claims, beneficiaries or healthcare merchants that are “normal” or “not unusual”. Each variable in the “good” model is rescaled, or transformed, into an “intermediate” score so the mid-point value of that variable receives a maximum score and the outer values in the ends, or tails, of the distribution receive a minimum score. The midpoint of a distribution is here defined as a measure of a data distribution's central tendency, such as the median, for example. As characteristics deviate from the mid-point value, they receive fewer points so that those values that are outliers receive near zero points. These low scoring outliers with their low point values then define the “non-normal” distributional boundaries and identify the opposite of “good”, or “normal”, characteristics.

This final “good” score is a single number that represents the likelihood that a particular provider, claim, beneficiary or healthcare provider is “good” or “normal”. This single, scalar value is derived by combining the multiple, individual variable scores into one value. Once all the individual variable scores are calculated, the final, total score is calculated that combines all the individual, variable scores into the one overall score. It is important to point out that the final score is a single valued function, even though it may originate from either the high side or the low side of the distribution. In order to distinguish which side of the distribution the scored observation originates, the low side scores have a “negative” value (less than “0”) and high side of the distribution scores have a positive value (greater than 0). Therefore, scores closest to zero (0) indicate the most “normal” or “typical” values, while high positive and high negative values indicate characteristics that are farthest from the midpoint and, therefore, assumed to be least “typical” or normal.

It is important to build a score that characterizes “normal” behavior in order to complement a score that describes “bad”, or fraudulent, abusive or wasteful, behavior because the data rich “good” characteristics tend to be more stable and predictable over time. Using non-parametric measures, such as the Median and Percentiles, helps to ensure that the underlying distributional irregularities do not negatively impact the calculation of the score. Additionally, “good” characteristics, by their nature, have relatively strong central tendency with distributions that have a declining end, if skewed, and ends, or “tails”, if not skewed, away from the midpoint, regardless of the underlying data distribution shape, limitations and restrictions. This “tailing away” behavior allows for specification of potentially “bad” behavior at the ends of the distributions, both above and below the “good” or “typical” middle range of values. Conversely, the extreme end of the distribution behavior characteristics also add strong credibility to “good-ness” for those observations that fall close to the distribution central tendency or median. Bad, or unusual, behavior can occur at the “low” end of the distribution as well as the “high” data value end of the distribution. For example, a fraudulent provider may submit a bill for procedures that rarely occur in a particular specialty and therefore be at the low end of the data distribution. Or, a provider may have an unusually low amount of activity where high activity is generally considered “normal”.

In summary, this invention uses non-parametric statistical measures and probability mathematical techniques to calculate deviations of variable values from the Midpoint of a data distribution. It transforms the raw data values for each variable into a cumulative distribution function (CDF) and then combines all of the individual variable CDF values into a single scalar value that is a “good-ness” score. This “good” behavior modeling develops a score that describes “goodness” or normality, rather than simply characterizing fraudulent, abusive or wasteful behavior, or “badness”. The good model can be used to compliment a fraud, abuse or waste prevention or detection model to reduce false positive rates. The “good” score can be viewed as a measure of how likely it is that the data comes from a population of behavior characteristics representing a “good” or “normal” provider, claim, beneficiary or healthcare merchant. The optimal fraud, abuse or waste prevention or detection risk management program or system should include both a “good” behavior model and a “bad” behavior score model.

### DESCRIPTION OF THE PRIOR ART

Pat. No.: 7,778,846
Filing date: Jul. 23, 2007
Issue date: Aug. 17, 2010
Application number: 11/781,887
Transition probability sequencing models and metrics are derived from
healthcare claims data to identify potentially fraudulent or abusive
practices, providers, doctors, clients, or other entities. Healthcare
reimbursement claims from hospitals, skilled nursing facilities, doctors,
etc., are processed to identify sequences of states, and transition
probability metrics are determined from frequency information pertaining
to the states. The metrics can these be further analyzed in predictive
or rule based models, or other tools.
Inventors: Nallan Suresh, Jean de Traversay, Hyma Gollamudi, Krassimir
G. Ianakiev, Anu Kumar Pathria, Michael K. Tyler
Original Assignee: Fair Isaac Corporation
Current Assignee: Search USPTO Assignment Database
Primary Examiner: Robert W Morgan
Attorney: Mintz, Levin, Cohn, Ferris, Glovsky and Popeo, P.C.

Pat. No.: 5,253,164
Filing date: Jan. 29, 1991
Issue date: Oct. 12, 1993
An expert computer system for processing medical claims. Medical claims
and associated representation are inputted into the expert computer system.
The inputted claims are interpreted according to specific rules and against
a predetermined database to determine whether the medical claims are
appropriate.
Inventors: Donald C. Holloway, Robert D. Hertenstein, George A.
Goldberg, Kelli A. Dugan
Original Assignee: HPR, Inc.
Current Assignee: Search USPTO Assignment Database

Pat. No.: 6,223,164
Filing date: Oct. 5, 1995
Issue date: Apr. 24, 2001
A method and system for analyzing historical medical provider billings
to statistically establish a normative utilization profile. Comparison of
a medical provider's utilization profile with a normative profile is
enabled. Based on historical treatment patterns and a fee schedule,
an accurate model of the cost of a specific medical episode can be
created. Various treatment patterns for a particular diagnosis can be
compared by treatment cost and patient outcome to determine the
most cost-effective treatment approach. It is also possible to identify
those medical providers who provide treatment that does not fall
within the statistically established treatment patterns or profiles.
Objective is to compare historical statistical profiles that are “norms”
based in clinically validated data and prepare reports, create a
practice parameter database of episodes of care of tables, -comparison
to norm is apparently based on rules, no statistical test.
Inventors: Jerry G Seare, Patricia A Smith-Wilson, Kurt VanWagoner,
Jean Andrea Mattey, Eileen K. Snyder, Candace C. Wahlstrom,
Michelle Willis, Matthew R. Bentley, Steven J. Wenzbauer, Rodney
Fredette, Vicki Sue Sennett
Original Assignee: Ingenix, Inc.
Current Assignee: Search USPTO Assignment Database

Pat. No.: 6,253,186
Filing date: Aug. 14, 1996
Issue date: Jun. 26, 2001
A computerized arrangement for detecting potentially fraudulent suppliers
or providers of goods or services includes a processor, a storage device,
an input device for communicating data to the processor and storage
device, and an output device for communicating data from the processor
and storage device. The storage device includes a claims data file for
storing information relating to a plurality of claims submitted for payment
by a selected supplier or provider, one or more encoding lookup tables for
use with the claims data file to produce an encoded claims data file, and a
neural network program for analyzing the encoded data to produce an
indicator of potentially fraudulent activity. The indicator may be compared
to a predetermined threshold value by the apparatus or method to identify
fraudulent suppliers. In addition to the neural network, at least one expert
system may be used in the identification process.
Inventor: E. Steele Pendleton, Jr.
Original Assignee: Blue Cross Blue Shield of South Carolina
Current Assignee: Search USPTO Assignment Database
Primary Examiner: Pedro R. Kanof

Pat. No.: 7,251,356
Filing date: Nov. 10, 2003
Issue date: Jul. 31, 2007
Application number: 10/703,425
A method for estimation of a fundamental matrix by selecting sets of
correspondence points is provided. According to the method, an entire
image is divided into several sub-regions, and the number of the inliers
in each sub-region and the area of each region is examined. The
standard deviation are used as quantitative measures to select a
proper inlier set. This method achieves a more precise estimation of
the fundamental matrix than conventional method does.
Inventors: Jung-Kak Seo, Cheung-Woon Jho, Hyun-Ki Hong
Original Assignee: Chung-ang University Industry Academic Cooperation
Foundation
Current Assignee: Search USPTO Assignment Database
Primary Examiner: Vikkram Bali
Attorney: Dickstein Shapiro LLP

Pat. No.: 7,813,937
Filing date: Feb. 6, 2003
Issue date: Oct. 12, 2010
Application number: 10/360,858
Transaction-based behavioral profiling, whereby the entity to be profiled is
represented by a stream of transactions, is required in a variety of data
mining and predictive modeling applications. An approach is described for
assessing inconsistency in the activity of an entity, as a way of detecting
fraud and abuse, using service-code information available on each
transaction. Inconsistency is based on the concept that certain
service-codes naturally co-occur more than do others. An assessment is
made of activity consistency looking at the overall activity of an individual
entity, as well as looking at the interaction of entities. Several approaches
for measuring consistency are provided, including one inspired by latent
semantic analysis as used in text analysis. While the description is in the
context of fraud detection in healthcare, the techniques are relevant to
application in other industries and for purposes other than fraud detection.
Inventors: Anu K Pathria, Andrea L Allmon, Jean de Traversay, Krassimir
G Ianakiev, Nallan C Suresh, Michael K Tyler
Original Assignee: Fair Isaac Corporation
Current Assignee: Search USPTO Assignment Database
Primary Examiner: Luke Gilligan
Attorney: Mintz, Levin, Cohn, Ferris, Glovsky and Popeo, P.C.

Pat. No.: 7,979,290
Filing date: May 24, 2010
Issue date: Jul. 12, 2011
Application number: 12/785,927
A computer-implemented method for profiling medical claims to assist
health care managers in determining the cost-efficiency and service
quality of health care providers. The method allows an objective means
for measuring and quantifying health care services. An episode treatment
group (ETG) is a patient classification unit, which defines groups that are
clinically homogenous (similar cause of illness and treatment) and
statistically stable. The ETG grouper methodology uses service or
segment-level claim data as input data and assigns each service
to the appropriate episode. The program identifies concurrent and
recurrent episodes, flags records, creates new groupings, shifts groupings
for changed conditions, selects the most recent claims, resets windows,
makes a determination if the provider is an independent lab and continues
to collect information until an absence of treatment is detected.
Inventor: Dennis K. Dang
Original Assignee: Ingenix, Inc.
Current Assignee: Search USPTO Assignment Database
Primary Examiner: Linh Michelle Le
Attorneys: Devan Padmanabhan, Dorsey & Whitney LLP

### BRIEF SUMMARY OF THE INVENTION

This invention uses non-parametric statistics and mathematical probability techniques to analyze historical healthcare claims data and to create a “characterization template” or “characterization score model” based on historical data which can then be used to score current, incoming claims or claim payment information for the purpose of evaluating whether a claim, group of claims, provider, beneficiary or healthcare merchant is considered to exhibit “normal good behavior” or “typical good behavior” compared to the historical data and compared to relevant peer groups. The overall score along with “reason codes” which are generated to aid in explaining why an observation scored as it did, are then deployed in a “production environment” to estimate and rank new claims, providers, beneficiaries and healthcare merchants on their relative likelihood of being “good” or “typical” or “normal”.

The score development and deployment sequence of steps is outlined below:
1. Sampling. Many fraud detection models in healthcare use simple random samples, which contribute to poorer model prediction performance and higher false positive rates. The structure of the healthcare industry requires that samples be stratified by segment to match the healthcare process for provider and beneficiary treatments and services. It is essential that all of the claims for a single provider be included in a characterization score model development sample, not a simple random sample of those claims.
2. First pass elimination of outliers. The complete score development process is a two stage model building procedure. First, a model is built using the central part of the distribution that is not influenced by outliers. Then, the model building steps are executed on the full distribution for all observations to create the final characterization model that describes the behavior pattern of normal or typical claims, providers, healthcare merchants and beneficiaries. Once the model is complete, it is then used to score incoming claims, providers, healthcare merchants or beneficiaries in order to determine how closely they fit the behavior pattern of this historical model.
3. Data reduction. The data may contain hundreds of variables so this large number must be reduced prior to final variable calculations. Reducing the number of variables in a characterization model, generally leads to performance improvement in models when performed correctly. At the beginning of score model development, there are several hundred potentially eligible variables for a particular model. These variables are analyzed statistically for their relevance and narrowed down to the number of variables that are eventually included in the final characterization model.
4. Calculation of Non-Parametric Statistics. For continuous or discrete interval variables, calculate mid-point and range statistics, such as quartiles and inter-quartile range.
5. G-Values. For each observation, each of the raw data characterization variables is then converted into a standardized positive or negative deviation from the distribution midpoint. This is accomplished by subtracting the overall midpoint value from the raw value for that variable and dividing by the difference of two percentiles for that variable, the 80^{th} and 20^{th} percentiles, for example.
6. H-Values. Each of the G-Values is then transformed into a cumulative distribution function (CDF) estimated probability value for each variable for each observation using a sigmoidal logistic transfer function. Cumulative Distribution Function is here defined as the likelihood that a variable with a given probability distribution will be found at a value less than or equal to the value calculated. These transformed variables are termed “H-values”.
7. Individual Variable T-Values. Because it is necessary to have a maximum “good” score at the individual variable's distribution midpoint, and because the H-value sigmoid function is a continuous “S” shaped CDF curve, it is necessary to transform the H-values to a value that increases as it approaches the distribution midpoint and then decreases after it passes the midpoint and moves toward zero as it continues to increase away from the distribution midpoint on the high variable value side of the distribution. This “pyramid” shaped distribution results in high scores when the variable value is near the distribution midpoint and low scores as the variable value surpasses or deviates from the distribution midpoint. In order to accomplish this peak valuation at the distribution midpoint, the H-values are transformed into T-Values by using the sigmoidal logistic transfer function.
8. Summary, Single Value T-Score—Combining All Individual T-Values into one T-Score. All of the “T-Values” associated with each of the individual variables for one observation, for example a particular provider, claim, beneficiary or a healthcare merchant, are then combined and transformed by “combining them” into one “overall” value, a score, that represents the likelihood that this particular transaction or observation, provider, claim, beneficiary or healthcare merchant is, overall, “normal” or “good”. This transformation is referred to as the “Sum-T” calculation. The “Sum-T” calculation converts the individual variable “T-Values” into a single summary variable, termed the “T-Score”, that represents the likelihood that the “sum” of the “T-Values” represents a “good” provider, claim, beneficiary or healthcare merchant. The “T-Score” value then represents the overall likelihood that this observation is typical or normal. This calculation combines all the T-Values for an individual observation and summarizes their combined values into one number to represent overall “good-ness”. These individual observation “T-Scores” can then be used to compare the relative performance, or normal or typical behavior, among a plurality of different healthcare providers, segments, or dimensions such as across geographies, multiple provider specialties, illness burden, morbidity or disease state. The Sum-T is the final fraud and abuse score.
9. Reason Codes. The next step in the score development and evaluation process is to calculate reason codes that explain why an observation scored as it did and explain why a total score is, for example high, or low, based on the individual variable intermediate scores or “T-Values”. The T-Values can be used because they are “normalized” values on the same scale across all the variables.
10. Deployment. The individual variable “normality” estimates are then combined into an overall “good” score, which is an estimate that the claim, provider, beneficiary or healthcare merchant associated with that particular observation, or group of variables, is “normal” or “typical”.

Characterization Template. The preceding steps are a characterization “template”, which is used to process input provider, claim, beneficiary or healthcare merchant transactions for scoring, evaluation and reason coding. A characterization predictive modeling schematic is presented graphically, as shown in FIG. 2. Each claim, provider, beneficiary and healthcare merchant, has a separate model and set of characterization variables that are designed, created and utilized to measure behavior.

The claim model dimension, for example, with further segmentation for healthcare segment or specialty group or geography, ascertains whether a specific claim has a likelihood of usual or normal behavior. A plurality of characterization variables can be used in the claim model to determine the likelihood of usual or normal behavior. Examples of characterization variables that may be included in a claims characterization model include, but are not limited to:
1) Beneficiary health
2) Beneficiary co-morbidity
3) Rare uses of procedures
4) Amount of provider effort expended
5) Dollar amount submitted per patient to be paid
6) Distance from provider to beneficiary
7) Fee amount submitted per claim
8) Sum of all dollars submitted for reimbursement in a claim
9) Number of procedures in a claim
10) Number of modifiers in a claim
11) Change over time for amount submitted per claim
12) Number claims submitted over time, for example in the last 30, 60, 90, 180 or 360 days
13) Total dollar amount of claims submitted in the last 30, 60, 90, 180 or 360 days,
14) Comparisons to 30, 60, 90, 180 or 360 day trends for amount billed or paid per claim
15) Sum of all dollars submitted in a claim
16) Ratio of current values to historical periods compared to peer group
17) Time between date of service and claim date
18) Number of lines with a proper modifier
19) Ratio of effort required to treat the diagnosis compared to the amount billed on the claim

The provider or healthcare merchant model dimension, with further segmentation for healthcare segment, specialty group, geography or illness burden, ascertains whether a specific provider or healthcare merchant has a likelihood of usual or normal behavior. A plurality of characterization variables can be used in the provider or healthcare merchant model to determine the likelihood of usual or normal behavior. Examples of characterization variables that may be included in a provider or healthcare merchant characterization model include, but are not limited to:
1) Beneficiary health
2) Number of claims
3) Beneficiary co-morbidity
4) Zip centroid distance, for example per procedure, or between patient and provider or healthcare merchant compared to peer group
5) Number of providers or healthcare merchants a patient has seen in a single time period
6) Proportion of beneficiaries seen during a time period, such as day, week or month that receive the same procedure, treatment, service or product versus their peer group
7) Likelihood of a fraudulent provider healthcare merchant address
8) Likelihood of a fraudulent provider healthcare merchant identity or business

The beneficiary model dimension, for example, with further segmentation for healthcare segment or specialty group or geography, ascertains whether a specific beneficiary has a likelihood of usual or normal behavior. Beneficiary demographics can also be used to provide further segmentation. A plurality of characterization variables can be used in the beneficiary model to determine the likelihood of usual or normal behavior. Examples of characterization variables that may be included in a claims characterization model include, but are not limited to:
1) Beneficiary health
2) Beneficiary co-morbidity
3) Time since visit to same provider or healthcare merchant
4) Time since visit to other/different provider or healthcare merchant
5) Percent of office visit or claim cost paid by beneficiary
6) Likelihood of a fraudulent beneficiary address
7) Number of claims in a fixed time period
8) Likelihood of a fraudulent beneficiary identity

Higher characterization score values for provider, claim, beneficiary or healthcare merchant characterization models indicate a higher likelihood that an observation is “normal” or “typical”. Lower score values indicate that an observation is abnormal or not typical.

“Good” provider, claim, beneficiary and healthcare merchant models, based upon the invention, are designed and created using a plurality of external data sources, for example, such as credit bureau, address or negative sanction files and historical healthcare data from past time periods, from 6 months, up to 3 years previously. Data is summarized, edited and “cleaned” by dealing with missing or incorrect information for each characteristic. In addition to the raw variables being used in the invention, a large number of variables are also designed and created, through transformations. Examples of transformations include the number of patients seen by a provider in one day, one week, one month or beneficiary co-morbidity and number of claims per patient in one month, 6 months and 1 year.

Characterization variables used to create models for each dimension in the invention are compared to peer group behavior, including but not limited to healthcare claims, providers, beneficiaries or healthcare merchants, to determine if their behavior is “typical” or normal of other participants in their peer group. A “peer group” is here defined as a group of members of the same dimension, including but not limited to healthcare claims, providers, beneficiaries or healthcare merchants. For example, a peer group for providers might be their medical specialty, such as pediatrics in a specified geography, such as one state or county.

Characterization score models from the invention are built using variables that can be used in a production environment when the model is deployed. Characterization variables used in the model must be adaptable to changing behavior trends or new conditions. For example, models in production must be able to calculate a score for a new provider, versus an existing provider.

Each claim, provider, beneficiary and healthcare merchant, model is designed, created and utilized to measure behavior and provide a final score to be used as a single number that represents “normal” or typical behavior. This final model score is then used in production by scoring new incoming claims as they are processed.

The “champion” or incumbent characterization model will continue to be used until another model is developed and enhanced and it then replaces the previous model in production. Predictive models are monitored, validated and optimized regularly. Models are optimized or redeveloped as experience is gained regarding the value of existing variables or the introduction of new models, model performance deteriorates or new information or new behavior patterns are identified, providing the opportunity for improvement. FIG. 3 diagrams the score model development process.

The final model is then put into production in a model deployment process where it is used to score separate predictive model dimensions, including but not limited to, claims behavior, provider behavior, beneficiary behavior and healthcare merchant behavior. The model can be deployed on a “real time” or “batch mode” basis. Real time scoring occurs as a claim is received and processed by the payer. The score can also be calculated in “batch mode” where it is calculated on all claims received in regularly scheduled batches, for example hourly or daily batches. FIG. 6 diagrams the production deployment scoring process.

### BRIEF DESCRIPTION OF THE DRAWINGS

FIG. 1 shows H[g] and T[g] Distributions

FIG. 2 shows a graphical representation of a predictive modeling schematic.

FIG. 3 is high-level block diagram showing the data preprocessing and score development and calculation process.

FIG. 4 shows a more detailed block diagram of the scoring process.

FIG. 5 is a block diagram of the Historical Data Summary Statistical Calculations.

FIG. 6 is a block diagram of characterization score calculation, validation and deployment process.

### DETAILED DESCRIPTION OF THE PREFERRED EMBODIMENTS

This invention uses non-parametric statistics and mathematical probability techniques to analyze historical healthcare claims data and to create a “characterization template” or “characterization scoring model” based on current and historical data. This model can then be used to score current, incoming claims, providers, beneficiaries or healthcare merchants for the purpose of evaluating whether an observation (claim, for example), group of claims, provider, beneficiary or healthcare merchant is considered to exhibit “normal good behavior” or “typical good behavior” compared to the historical data and compared to relevant peer groups. Each of the variables on the incoming group of claims is converted to an estimate that the individual variable displays “normal” or “typical” characteristics or values. Some entities, in a general sense, refer to this mathematical estimate as a “profile”. The goal then is to build a characterization scoring model from historical medical claims from this valid data that define and describe the “normal” or “typical” claim, provider, beneficiary and healthcare merchant patterns of behavior. The entire score development and deployment sequence of steps are outlined below. The complete set of transformations that are involved in the data analysis and characterization score development and deployment process are performed in the following manner.

1. Non-Parametric Statistical Calculations

For continuous or discrete interval variables, perform the following steps individually for each of these characterization variables. Since it is hypothesized that at least the bulk of a variable's distribution is homogeneous, define a “reasonable” centralized homogeneous mid-fractional (equally-sized tails) data distribution area of containment of size 0, initially, for example, 0=0.80=the mid 80% of the distribution. This area is an estimate of the data distribution's homogeneous area for that variable. Then determine numerically the boundary percentiles for that 0:

P-low, L=P %[(1−β)/2], and

P-high, H=P %[(1+β)/2], for that variable.

If β=0.80, then P-low is the 10^{th} percentile value of that particular variable and P-high is the 90^{th} percentile value of that particular variable. Then calculate:

R=(H−L)/β; the projected (estimated) 100% range of the distribution

MP=(H+L)/2; the projected (estimated) symmetric distribution mid-point

LB=MP−R/2; the projected (estimated) 0^{th} %-ile distribution lower bound

UB=MP+R/2; the projected (estimated) 100^{th} %-ile distribution upper bound

The estimated midpoint of a distribution is a non-parametric measure of a data distribution's central tendency (its centrality). It can be measured by several different statistics such as the arithmetic mean, the median, and (as developed here) the projected mid-point. If the data are symmetric and everywhere homogeneous in nature, these various measures will tend to be equal to the same value. If, however, the distribution is heterogeneous, bimodal or skewed, or if it contains significant outliers, then these central tendency measures will return differing values, depending upon the degree and scope of the heterogeneity and skewness. Skew is defined here as the degree of asymmetry of the distribution around the selected measure of centrality (often the mode for homogeneous distributions), where the body or tail on one side of the distribution is consistently longer than that of the other. It is important to note here the difference between overall homogeneous skewness of a distribution (the result of a naturally skewed physical process), as compared to the effect significant outliers can have on the “apparent skewness” of a fundamentally homogeneous un-skewed distribution. One of the primary challenges facing an outlier detection system is to be able to distinguish accurately, consistently, and with precision, the naturally skewed but well-behaved distribution (the desired “good guys” data distribution format) from the distribution that also contains maverick outliers (the undesired “bad guys”).

2. Distribution Mid-Point Deviations—G-Values

As an observation is processed, each of the raw data characterization variables is converted into a standardized positive or negative deviation from the distribution midpoint using non-parametric statistical techniques. This deviation calculation is calculated by subtracting the variable's midpoint value from the raw data value and then dividing this difference by R/2, half the projected 100% range of the distribution, for each observation for each variable. The result of this calculation is termed the “G-Value” for a particular, individual x-variable for each observation in the data. The G-Value calculation for each x-variable observation is:

g[x]=ωₓ·(x−MP)/(R/2), or

g[x]=ωₓ·[2·(x−MP)/R]

where
ωₓ=optional variable importance weighting factor for variable x (0≦ωₓ≦1)

Note: hereafter ωₓ=1 to simplify notation and analyses (excepting binaries as noted)

β=assumed mid-homogeneity Span; [0.5≦β<1]

L=P %[(1−β)/2]; H=P %[(1+β)/2]

MP=(H+L)/2; R=(H−L)/β

Choosing an optimal value for the β is important in that it optimizes the trade-off between the potential for false-positive and false negative conclusions as well as the potential total percent of estimated “good” or “typical” or “normal” observations. A false-positive is defined as reaching the conclusion that a variable value is a maverick outlier when it naturally is not, whereas a false-negative is reaching the conclusion that a variable value is a member of the homogeneous, typical distribution when it is not. Unless it is practical to examine every observation individually and in detail, false positives and false negatives are unavoidable outcomes of large-volume decision-making models.

3. Cumulative Distribution Function Estimates—H-Values and Lambda

In order to better understand non-zero variable G-Values and their likelihood, each value is transformed into a Cumulative Distribution Function (CDF) value using a simple sigmoid logistic transfer function. A CDF is here defined as a mathematical function that describes the probability that a variable's value is found at a value less than or equal to the distributional value. The general sigmoid function Sig is of the form

Sig[t]:=1/(1+e^{-t}), −∞<t<∞

Note that for real values oft, Sig[t] is everywhere positive and ranges from 0 to 1. These sigmoid transformed variables are identified as H-Values, and these H-Values are made a function of g[x] above. The specific formula used for H-Value computations is:

H[x≦x₀]=1/(1+e^{-λ·g[x]})

where g[x] is the G-Value described and calculated above, and Lambda, λ, is a scaling coefficient that adjusts the H-equation so that g[x]=1 which provides an H-Value probability of (1+β)/2, and g[x]=−1 provides an H-Value probability of (1−β)/2. The following calculations are made to determine the λ value:

For g[x]=1

H[g[x]=1]=1/(1+e^{-λ·1})=(1+β)/2

e^{-λ}=2/(1+β)−1=(1−β)/(1+β)

λ=Ln [(1+β)/(1−β)]

Note the desired symmetry for g[x]=−1:

H[g[x]=−1]=1/(1+e^{-λ·-1})=(1−β)/2

e^{λ}=(1+β)/(1−β)

λ=Ln [(1+β)/(1−β)]

For example, for {β=0.9}→λ=2.944. Note that λ is a function only of β, not x, and so the determination of β (and thus the associated λ) should be made individually for each variable based on the assumption of the scope of homogeneity and shape of that variable's distribution.

4. Transformation to T-Values.

For decision-making and variable value inlier identification it is desired to have a maximum “good guy” score at the individual variable's distribution midpoint (MP) and have progressively smaller scores away from that MP, in both the positive and negative direction from the MP. To accomplish this maximum value at the midpoint, the G-Values are transformed into associated T-Values as follows.

T[g[x]]=2/(1+e^{|λ·g[x]|}); 0<T[g[x]]<1, |y|→absolute value of y,

therefore, |k·g[x]|=absolute value of k·g[x].

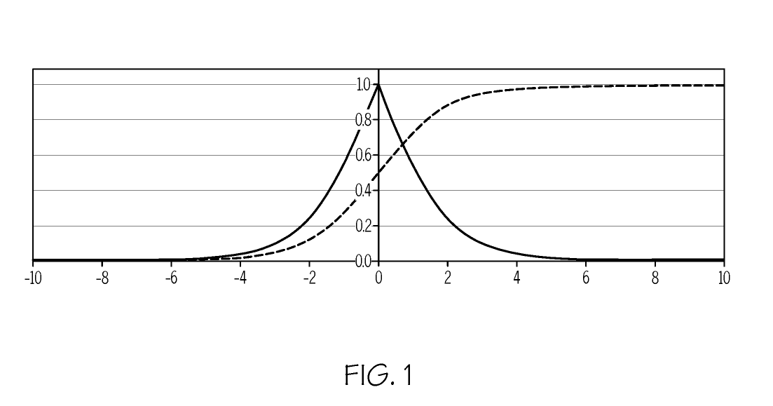

The resulting triangular T transform has a maximum value of 1 at g[x]=0, which occurs when x=MP, and tails off quickly toward zero as absolute value g[x], |g[x]|, becomes large. The T-Value is a pyramid shaped distribution rather than sigmoid, but tends to follow the distributional shape of the H[g] tails, as illustrated in FIG. 1, which illustrates a typical display of H[g] and T[g].

5. Binary Variables—T-Transformation.

If they are present in the data as contributors rather than simply discriminators, binary variables can also be included in this T-Value transformation process. Numeric binary variables are defined here as data that have only two numeric indicator values, such as zero and one (b i: 0, 1). Because of this restriction they are much simpler to address mathematically than are wide-ranging interval variables. Specifically, assume that the occurrence of an event or condition ξ, is coded 1 and its non-occurrence 0. Examination of the N observations in the data indicates that ξ occurs in Phi, φ, proportion of the N observations and does not occur in (1−β) proportion of the N. Since binaries have only two dimensionless numeric states, for example zero and one (0,1), the T transformation can be done directly, rating the binaries as follows:

bi=1: T[1]=ω_{b}·φ

bi=0: T[0]=ω_{b}·(1−φ)

where, Omega, ω_{b} (0≦w≦1) is an importance-weighting constant for that binary variable, similar to Omega, ωₓ for the g-computation. Note then that for all such binary variables:

T[1]+T[0]=ω_{b}·φ+ω_{b}(1−φ)=ω_{b}

6. Summarization—Combining T-Values into One Overall T-Score.

Observations almost always consist of more than one variable and these variables together, as a composite, may indicate overall observational goodness or normalcy, so a summary statistical measure is needed that allows for meaningful accumulation of individual variable measures, such as combining all the T-Values. All of the T-Values associated with each of the individual variables for one observation, for example a particular provider, claim, beneficiary or a healthcare merchant, can then be combined into one overall T-Score, that represents the likelihood that this particular transaction or observation, provider, claim, beneficiary or healthcare merchant is, overall, “normal” or “a good guy”. This transformation is referred to as the observation's “ΣT-Score” (Sigma-T-Score or Sum-T) calculation. This ΣT calculation accumulates the individual variable T-Scores into a single summary score, where summary values near 1 indicate overall homogeneous good-guy behavior, and scores approaching zero indicate suspicious non-homogeneous (possible outlier) behavior. As such the ΣT score will be the final fraud, abuse and waste score for an observation. The ΣT-score is defined by control-coefficients φ (phi) and δ (delta), by the following formula.

ΣT_{φ,δ}=[Σ_{t=1,k}ωₜ·Tₜ^{φ+δ}]/[Σ_{t=1,k}ωₜ·Tₜ^{φ}]
Where, ωₜ is the weight for variable Tₜ, (0≦ωₜ≦1, use of ωₜ is optional);
φ (phi) is the selected power base, such as 0, 1, 2, 3, 4, etc.;

δ (delta) is a power increment, such as 1, 1.2, 1.8, 2.1, 3.0, etc. (Note that for this invention φ and δ are both positive, but do not need to be integers.) The ΣT-Score is the summary estimate of all of the variables and how they combine to create an overall estimate of “goodness” for each observation (T-Score).

7. Reason Code List.

The next step in the score development and evaluation process is to create a reason code list that explains why observations with the lowest ΣT scores scored as they did, based on the component individual variable T-Scores. The characterization variable associated with the smallest T-Value for that observation is the primary, number one variable, and therefore reason, that contributed negatively (i.e., is the least “normal” or “typical”) to the overall “good-guy” score for the provider, claim, beneficiary or healthcare merchant being scored. The variable with the second smallest T-Value is the next highest negative contributor, etc.

8. Score Deployment.

The final step in developing a scoring model is to deploy it so it can be used to score a large block of new, incoming transactions. Each of the variables on the incoming claims is converted to a G-Value and, ultimately a T-Value that indicates the individual variable's values that express “typical” or “normal” characteristics of this variable. These individual variable estimates are then combined into an overall ΣT score, which is an estimate of the overall degree to which the claim, provider, beneficiary or healthcare merchant associated with that particular observation, or group of variables, is typical or normal and acceptable, i.e., an inlier. The individual T-Value and overall ΣT scores (along with necessary reason codes) are part of the deployed “production environment” which scores new claims, providers, beneficiaries and healthcare merchants on their relative likelihood of being “good” or “typical” or “normal”.

9. Summary.

While this invention may be embodied in many different forms, there are described in detail herein specific preferred embodiments of the invention. This description is an exemplification of the principles of the invention and is not intended to limit the invention to the particular embodiments illustrated. The present invention is a “Normal-Behavior Characterization Scoring Model” that is designed to focus primarily on normal or typical values of the variable distributions for each observation scored by the model. The individual T and summary ΣT scores are hereby defined as the values that represent the likelihood that one or more of the claims, provider, beneficiary or healthcare merchant characterization variables, are likely to represent normal or typical behavior. The highest scores are closer to the midpoint of the variable values or the observation's data distribution, while the lowest scores are farther from the distribution midpoint.

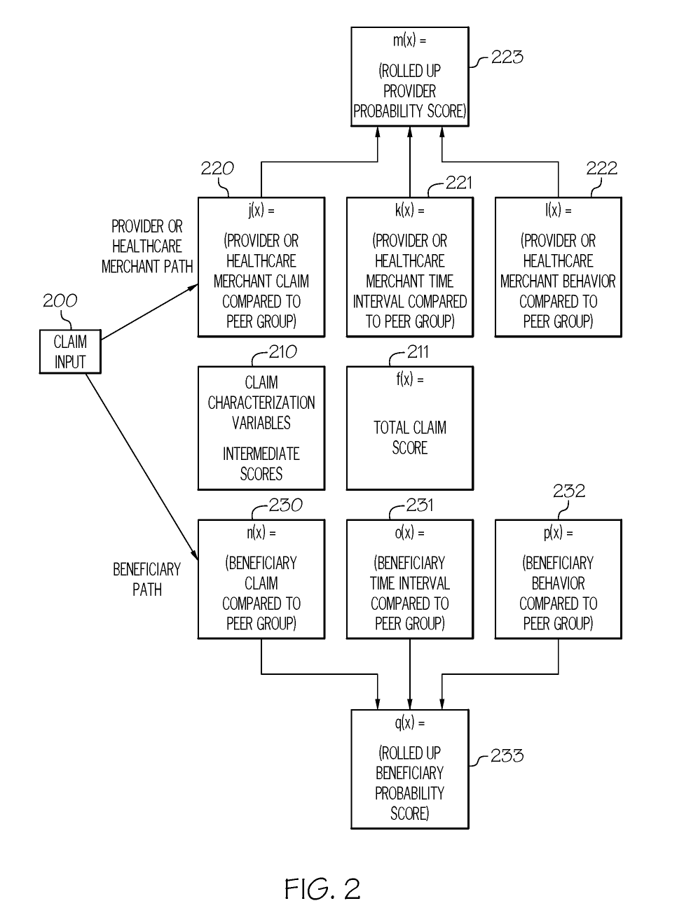

Referring now to FIG. 2, the present invention uses the following procedures to calculate a “Claim” score, a “Provider” score, a “Beneficiary” score or a “Healthcare Merchant” score. The first step, 200 in this process for the present invention analyzes the individual healthcare claim input and sends it to one or more of the following score processes: Claim's Score 210, Provider's Score or Healthcare Merchant's Score 220, Beneficiary Score 230. The data is then “cleaned” and pre-processed, characterization variable transformations are performed and variable scores are calculated at Claims 210, 211, Provider or Healthcare Merchant 220, 221 and 222 and Beneficiary 230, 231 and 232. The intermediate scores from Claims 210 are sent to the Final Score calculation module at Claims 211. The intermediate scores from Provider or Healthcare Merchant 220, 221 and 222 are sent to Final score calculation module Provider or Healthcare Merchant 223. The individual intermediate scores from Beneficiary 230, 231 and 232 are sent to the Final Score calculation module at Beneficiary 233.

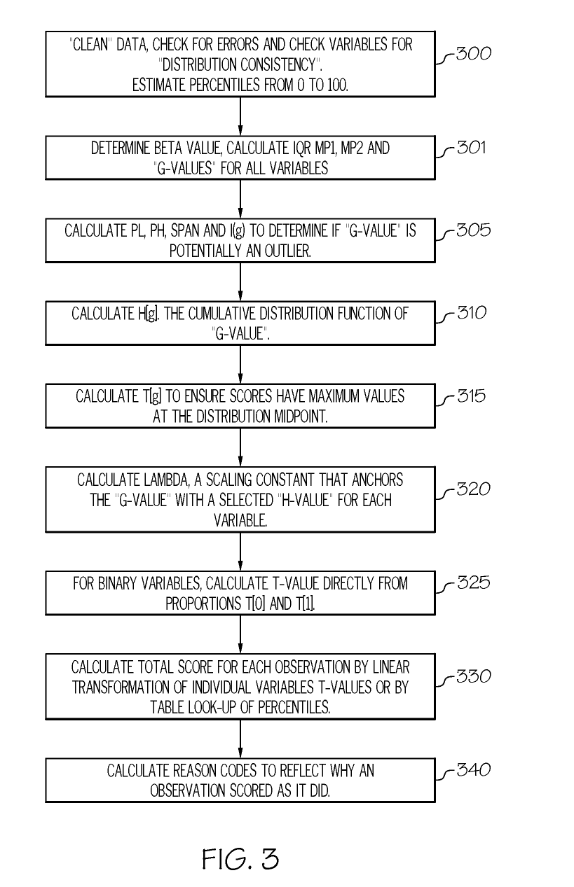

Referring now to FIG. 3, the present invention uses the following procedures to calculate the likelihood that any or all of these characterization variables in the scoring model represents normal or typical behavior. The first step 300 in this process in the present invention is the “cleaning” of the data, error checking and distribution consistency check. Then step 301 determines the Beta value to be used in subsequent calculations. This Beta value is determined by evaluating the data distributions and consistency checks in step 300, but it is generally a value between 0.7 and 0.9. Beta can be thought of as the middle percent of the distribution that is homogeneous or “normal” and not skewed or abnormal in some other way. Also calculated in step 301 for all the integer variables are the inter-quartile ranges, MP1, MP2 and G-Values. Then in step 305 the present invention calculates PL, PH, Span and I-Value to determine if the G-Value for each characterization variable reflects the fact that the characterization variable is a possible outlier. In step 310, the H-Value is calculated in order to determine the cumulative distribution function of the G-Value. At step 315 the T-Value is calculated to compute each characterization variable's distance from that variable's Midpoint. At step 320 the Lambda is calculated to provide for a scaling constant that anchors the G-Value for each characterization variable. For binary characterization variables, coded as either “1” or “0”, step 325 calculates the T-value directly from the binary characterization variable's proportion of either T[1] or T[0]. At step 330, the Total Score is calculated for each observation by either a linear transformation of individual variable T-values or via table list or look-up of the normalized percentile values of the variable T-Values. Last, step 340 calculates the Reason Codes that explain why an observation scored as it did by ranking the individual T-Values from high to low and using the corresponding variable descriptions as reasons.

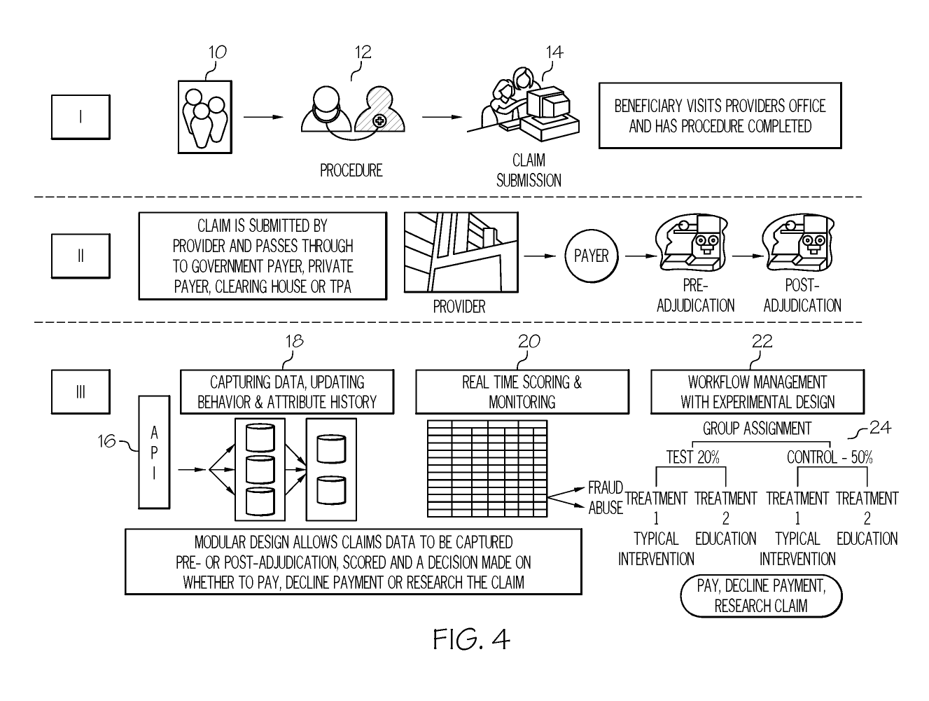

The overall scoring process is shown in FIG. 4. For example, the patient or beneficiary 10 visits the provider's office and has a procedure 12 performed, and a claim is submitted at 14. The claim is submitted by the provider and passes through to the claims processing flow, such as a Government Payer, Private Payer, Clearing House or TPA, as is well known in this industry. Using an Application Programming Interface (API) 16, the claim data can be captured at 18. The claim data can be captured either before or after the claim is adjudicated. Real time scoring and monitoring is performed on the claim data at 20. The Fraud Risk Management design includes Workflow Management 22 to provide the capability to utilize principles of experimental design methodology to create empirical test and control strategies for comparing test and control models, criteria, actions and treatments. Claims are sorted and ranked within decision strategies based upon user empirically derived criteria, such as score, specialty, claim dollar amount, illness burden, geography, etc. The characterization score, reason codes, recommended treatment and action, along with the claim, is then displayed systematically so an investigations analyst can review. Monitoring the performance of each strategy treatment allows users to optimize each of their strategies to encourage good providers with enticements or to send notices to good providers whose scores are beginning to deteriorate. It provides the capability to cost-effectively queue and present only the highest risk and highest value characterization scoring claims to analysts to research or treatment. The high scoring transactions are systematically presented to investigations analysts at 22 and decisions, actions or treatments made at 24, such as pay claim, deny payment or research further.

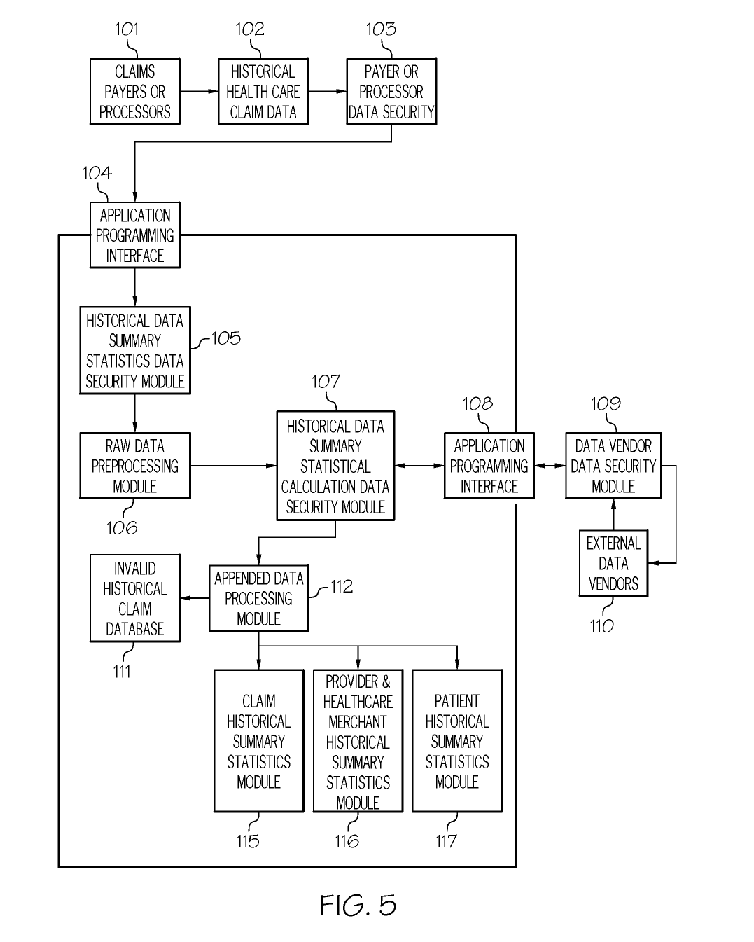

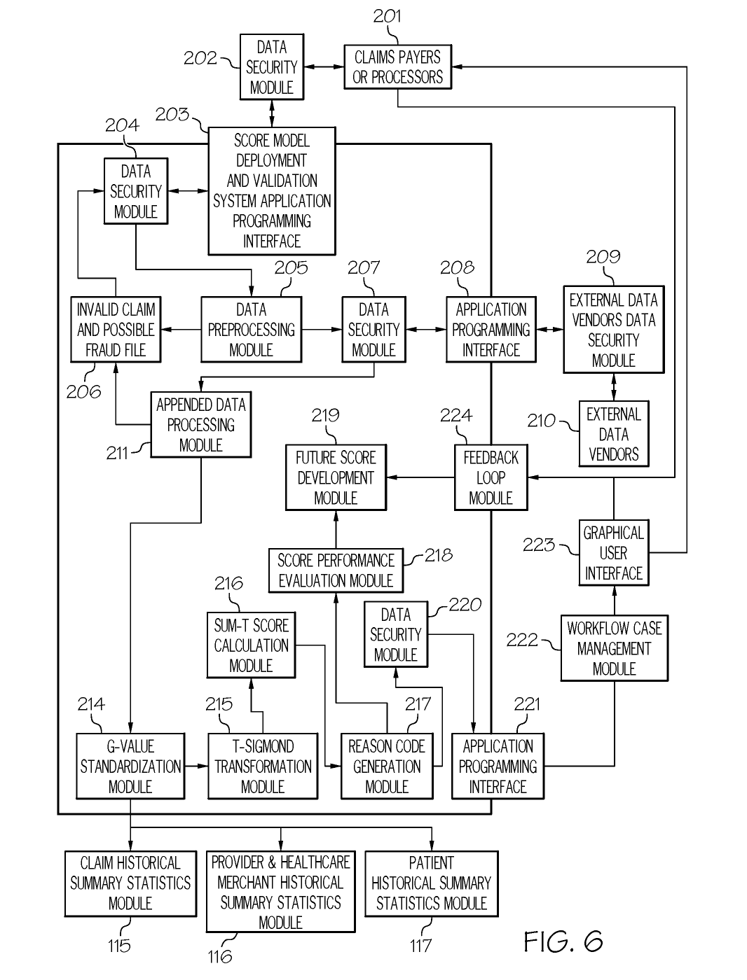

Referring now to FIG. 5 as a perspective view of the technology, data system flow and system architecture of the Historical Data Summary Statistical Calculations there is a plurality of sources of historical data housed at a healthcare Claim Payer or Processors Module 101. Data can also come from, or pass through, government agencies, such as Medicare, Medicaid and TRICARE, as well as private commercial enterprises such as Private Insurance Companies, Payers, Third Party Administrators, Claims Data Processors, Electronic Clearinghouses, Claims Integrity organizations that utilize edits or rules and Electronic Payment entities that process and pay claims to healthcare providers). This data and the processes described in FIG. 5 are used to build a characterization score model that will then be deployed in a production environment described in FIG. 6. The claim processor or payer(s) prepare for delivery of historical healthcare claim data processed and paid at some time in the past, such as the previous year for example, Historical Healthcare Claim Data Module 102. The claim processor or payer(s) send the Historical Healthcare Claim Data from Module 102 to the Data Security Module 103 where it is encrypted. Data security is here defined as one part of overall site security, namely data encryption. Data encryption is the process of transforming data into a secret code by the use of an algorithm that makes it unintelligible to anyone who does not have access to a special password or key that enables the translation of the encrypted data to readable data. The historical claim data is then sent to the Application Programming Interface (API) Module 104. An API is here defined as an interaction between two or more computer systems that is implemented by a software program that enables the efficient transfer of data between two or more systems. The API translates, standardizes or reformats the data for timely and efficient data processing. The data is then sent via a secure transmission device, to the Historical Data Summary Statistics Data Security Module 105 for un-encryption.

From the Historical Data Summary Statistics Data Security Module 105 the data is sent to the Raw Data Preprocessing Module 106 where the individual claim data fields are then checked for valid and missing values and duplicate claim submissions. The data is then encrypted in the Historical Data Summary Statistics External Data Security Module 107 and configured into the format specified by the Application Programming Interface 108 and sent via secure transmission device to an external data vendor's Data Vendor Data Security Module 109 for un-encryption. External Data Vendors Module 110 then append(s) additional data such as Unique Customer Pins/or Universal Identification Device (UID) to assign proprietary universal identification numbers, to append, for example, the Social Security Death Master File, Credit Bureau such as credit risk scores and/or a plurality of other external data and demographics, Identity Verification Scores and/or Data, Change of Address Files for Providers or Healthcare Merchants, including “pay to” address, or Patients/Beneficiaries, Previous provider, healthcare merchant or beneficiary fraud “Negative” (suppression) files or tags (such as fraud, provider sanction, provider discipline or provider licensure, etc.), Eligible Beneficiary Patient Lists and Approved Provider or Healthcare Merchant Payment Lists. The data is then encrypted in the Data Vendor Data Security Module 109 and sent back via the Application Programming Interface in Module 108 and then to the Historical Data Summary Statistics External Data Security Module 107 to the Appended Data Processing Module 112. If the external database information determines that the provider, healthcare merchant or patient is deemed to be deceased at the time of the claim or to not be eligible for service or to not be eligible to be reimbursed for services provided or is not a valid identity, at the time of the original claim date, or any other reason not considered here today, the claim is tagged as “invalid historical claim” and stored in the Invalid Historical Claim Database 111. These claims are suppressed “negative” files for claim payments and may or may not be used in calculating the summary descriptive statistical values for the “Good Provider” characterization score. They may be referred back to the original claim payer or processor and used in the future as an example of fraud. The valid claim data in the Appended Data Processing Module 112 is reviewed for valid or missing data and a preliminary statistical analysis is conducted summarizing the descriptive statistical characteristics of the data.

A copy of claim data is sent from the Appended Data Processing Module 112 to the Claim Historical Summary Statistics Module 115 where the individual values of each claim are accumulated into a claim characterization score using calculated variables by industry type or segment, provider, healthcare merchant, patient, specialty and geography. Examples of individual claim variables include, for example, but are not limited to: fee amount submitted per claim, sum of all dollars submitted for reimbursement in a claim, number of procedures in a claim, number of modifiers in a claim, change over time for amount submitted per claim, number claims submitted in the last 30/60/90/360 days, total dollar amount of claims submitted in the last 30/60/90/360 days, comparisons to 30/60/90/360 trends for amount per claim and sum of all dollars submitted in a claim, ratio of current values to historical periods compared to peer group, time between date of service and claim date, number of lines with a proper modifier, ratio of amount of effort required to treat the diagnosis compared to the amount billed on the claim.

Within the Claim Historical Summary Statistics Module 115, a plurality of historical descriptive statistics are calculated for each variable for each claim by industry type, specialty and geography. Calculated historical summary descriptive statistics include measures such as the median and percentiles, including deciles, quartiles, quintiles or vigintiles. Examples of historical summary descriptive non-parametric statistics for a claim would include values such as median number of procedures per claim, median number of modifiers per claim, median fee charged per claim.

The historical summary descriptive statistics, for each variable in the characterization score model, are used by G-Value Normalization Module 214 in order to calculate normalized variables related to the individual variables for the scoring model.

A copy of the data is sent from the Appended Data Processing Module 112 to the Provider and Healthcare Merchant Historical Summary Statistics Module 116 where the individual values of each claim are accumulated into claim characterization score variables by industry type, provider, healthcare merchant, specialty and geography.

Within Provider Historical Summary Statistics Module 116, a plurality of historical summary descriptive statistics are calculated for each variable for each Provider and Healthcare Merchant by industry type or segment, specialty and geography. Calculated historical descriptive statistics include measures such as the median, range, minimum, maximum, and percentiles, including deciles, quartiles, quintiles and vigintiles for the Physician Specialty Group.

The Provider and Healthcare Merchant Historical Summary Statistics Module 116 for all industry types and segments, specialties and geographies are then used by the G-Value Standardization Module 214 to create normalized variables for the scoring model.

A copy of the data is sent from the Appended Data Processing Module 112 to the Patient, or beneficiary, Historical Summary Statistics Module 117. A plurality of historical summary descriptive statistics are calculated for the individual values of the claim and are accumulated for each claim characterization score variable by industry type or segment, patient, provider, healthcare merchant, specialty and geography for all Patients, or Beneficiaries, who received a treatment, or supposedly received a treatment.

The Patient Historical Summary Statistics 117 for all industry types, specialties and geographies is then used by the G-Value Standardization Module 214 to create normalized variables.

Referring now to FIG. 6 as a perspective view of the technology, data system flow and system architecture of the Score Calculation, Validation and Deployment Process there is shown a source of current healthcare claim data sent from Healthcare Claim Payers or Claims Processor Module 201 for scoring the current claim or batch of claims aggregated to the Provider, Healthcare Merchant or Patient/Beneficiary level in real time or batch. Referring now to FIG. 6 as a perspective view of the technology, data system flow and system architecture of the Score Calculation, Validation and Deployment Process there is shown a source of current healthcare claim data sent from Healthcare Claim Payers or Claims Processor Module 201. Data can also come from, or pass through, government agencies, such as Medicare, Medicaid and TRICARE, as well as private commercial enterprises such as Private Insurance Companies, Third Party Administrators, Claims Data Processors, Electronic Clearinghouses, Claims Integrity organizations that utilize edits or rules and Electronic Payment entities that process and pay claims to healthcare providers for characterization scoring the current claim or batch of claims aggregated to the Provider or Patient/Beneficiary level. The claims can be sent in real time individually, as they are received for payment processing, or in batch mode such as hourly or at end of day after accumulating all claims received during one business day. Real time is here defined as processing a transaction individually as it is received. Batch mode is here defined as an accumulation of transactions stored in a file and processed all at once, periodically, such as hourly or at the end of the business day. Batch may also have a definition where a large file is received on a scheduled basis, yet records are loaded and processed individually, versus all at once, using a traditional batch definition. Claim payer(s) or processors send the claim data to the Claim Payer/Processor Data Security Module 202 where it is encrypted.

The data is then sent via a secure transmission device to the Score Model Deployment and Validation System Application Programming Interface Module 203 and then to the Data Security Module 204 within the scoring deployment system for un-encryption. Each individual claim data field is then checked for valid and missing values and is reviewed for duplicate submissions in the Data Preprocessing Module 205. Duplicate and invalid claims are sent to the Invalid Claim and Possible Fraud File 206 for further review or sent back to the claim payer for correction or deletion. The remaining claims are then sent to the Internal Data Security Module 207 and configured into the format specified by the External Application Programming Interface 208 and sent via secure transmission device to External Data Security Module 209 for un-encryption. Supplemental data is appended by External Data Vendors 210 such as Unique Customer Pins/Universal Identification Descriptors (UID) Social Security Death Master File, Credit Bureau scores and/or plurality of other external data and demographics, Identity Verification Scores or Data, Change of Address Files for Providers, Healthcare Merchants or Patients/Beneficiaries previous provider, healthcare merchant or beneficiary fraud “Negative” (suppression) files, Eligible Patient and Beneficiary Lists and Approved Provider or Healthcare Merchant Lists. The claim data is then sent to the External Data Vendors Data Security Module 209 for encryption and on to the External Application Programming Interface 208 for formatting and sent to the Internal Data Security Module 207 for un-encryption. The claims are then sent to the Appended Data Processing Module 211, which separates valid and invalid claims. If the external database information reveals that the patient or provider is deemed to be inappropriate, such as deceased at the time of the claim or to not be eligible for service or not eligible to be reimbursed for services provided or to be a false identity, the claim is tagged as an inappropriate claim or possible fraud and sent to the Invalid Claim and Possible Fraud File 206 for further review and disposition.

A copy of the individual valid current claim or batch of claims is also sent from the Appended Data Processing Module 211 to the G-Value Standardization Module 214 in order to create claim level variables for the characterization score model. In order to perform this calculation the G-Value Standardization Module 214 needs both the current claim or batch of claims from the Appended Data Processing Module 211 and a copy of each individual valid claim statistic sent from the Claim Historical Summary Statistics Module 115, Provider and Healthcare Merchant Historical Summary Statistics Module 116 and Patient Historical Summary Statistics Module 117. The G-Value Standardization Module 214 converts raw data individual variable information into non-parametric values. When using the raw data from the claim, plus the statistics about the claim data from the Historical Claim Summary Descriptive Statistics file modules, the G-Value Standardization Module 214 creates G-Values for the scoring model. The individual claim variables are matched to historical summary claim behavior patterns to calculate the current individual claim's historical behavior pattern of a peer group of claims. These individual and summary evaluations are non-parametric, value transformations of each variable related to the individual claim. The calculation for the G-Value transforms the raw data value for each x, into a dimensionless scaled variable g[x], where wₓ is an assigned importance-weighting constant (0≦w≦1) for variable x. The initial value for wₓ is unity (1.0) unless it is known or believed that the variable should have less weight, then the value of wₓ is less than 1.0.

g[x]=wₓ·(x−MP2ₓ)/IPRₓ

Note the characteristics of g[x]. It can range from −∞ to +∞, and has a value of zero at the projected β midpoint MP2ₓ. If the data are naturally skewed, using MP2 for the measure of centrality instead of Q2, tends to compress the longer leg of the g[x] distribution and extend the shorter leg of g[x].

The T-Value Sigmoid Transformation Module 215 converts the G-Value normalized variables into estimates of the likelihood of being a normal behavior pattern. It is important to have a single measure of likelihood of observing a large but legitimate value for each variable that will be a part of the characterization scoring model. Therefore, the T-Sigmoid Transformation Module 215 converts the G-Values in G-Value Standardization Module 214 to a sigmoid-shaped distribution that approximates a traditional cumulative distribution function (CDF).

This T-Value provides an estimate that the raw data value for this observation has a normal or typical pattern of behavior. All characterization variables and their corresponding T-Values are then sent from the T-Value Sigmoid Transformation Module 215 to the Sum-T Score Calculation Module 216. At this point there is a collection of n-different T-Value values for each of the “n” variables in the score model. Each characterization variable measures a different characteristic of the individual claim, or batch of claims, the Provider, the Healthcare Merchant and the Patient. These characterization variable values, T-Values, that are estimates of being a normal or typical pattern, can then be aggregated into a single value, Sum-T. This Sum-T function is used to obtain one value, a score, which represents an estimate of the overall likelihood that the current observation reflects a normal or typical pattern of behavior. Because it is necessary to have a maximum “Good” score at the distribution midpoint, and because the H-value sigmoid function is a continuous “S” shaped CDF curve, it is necessary to transform the H-values to a value that increases as it approaches the distribution midpoint and then decreases after it passes the midpoint and moves toward zero as it continues to increase away from the distribution midpoint. In order to accomplish this peak valuation at the distribution midpoint, the H-values are transformed to T-values by using the same sigmoidal logistic transfer function, except the absolute value of the term [−λ·g] is used and the numerator is “2” instead of “1”. Absolute value is here defined as the numerical value of a without regard to its positive or negative sign. This formula results in increasing values from the lowest percentile up to the distribution midpoint and then decreasing values from the midpoint to the highest percentile value. The individual T-Values can be thought of as individual variable “scores” or “intermediate” characterization scores. Note that with all the above steps completed, there is now a characterization score determined solely in terms of the predetermined λ-value and the computed g[x] for that observation's variable value. The formula for the T-value is:

T[g]=2/(1+exp[|λ·g]|)

All of the transformed “T-Values” for the characterization variables for one observation, for example a particular provider, healthcare merchant, claim or beneficiary, are then combined and transformed by combining them into one “overall” value, a characterization score, that represents the likelihood that this particular transaction or observation, provider, healthcare merchant, claim or beneficiary, is “normal”, “typical” or “good”. This T-value transformation can be done using one of two methods. The first method begins by identifying and listing all the possible percentile decimal values between 0.005 and 0.995, in increments of 0.01, with added delimiters of 0 and 1. The list of percentiles begins a tabular “process-of-location” where the variables, for each observation, can be “fit” into a percentile rank as a value in the cumulative distribution function. Each variable for each observation is “transformed” to create a “standardized” percentile, or a common percentile rank value, so that all the variable percentile values can be compared to one another. These “standardized” percentile values are then combined, using, for example, a geometric mean, to calculate a final, single, overall “Good” characterization score for that observation. In order to further screen for “good” or normal behavior, the variability of the T-Values can be used to measure “normal behavior consistency” using, for example the geometric standard deviation, or the minimum of the ratio of the low T-Value to the maximum T-Value. These statistics will provide a measure of the variability and consistency of the T-Values and provide an indication whether a group of variables are tightly centered about the average T-Value or have a wide dispersion about the T-Value measure of central tendency. The “Sum-T” calculation converts, for a set of “T-Values”, into a single summary variable that represents the likelihood that the “sum” of the “T-Values” represents a “good” provider, claim, beneficiary or healthcare merchant. The “Sum-T” value then represents the overall likelihood that this observation is typical or normal. This calculation combines the T-Values for an individual observation and summarizes their combined values into one number to represent overall “good-ness”. These individual observation “Sum-T” scores can then be summed and aggregated to compare the relative performance, or normal behavior, among a plurality of different healthcare segments, or dimensions such as geographies or across multiple provider specialties. The formula for the Sum-T is:

ΣT_{φ,δ}=[Σ_{t=1,k}ωₜ·Tₜ^{φ+δ}]/[Σ_{t=1,k}ωₜ·Tₜ^{φ}] Sum-T:

where ΣT, Sum-T, is the summary estimate of all of the normalized score variable estimates for the characterization variables for one observation, which is the “score” for this observation, wt is the weight for variable Tt, φ (Phi) is a power value of Tt, such as 1, 2, 3, 4, etc. and δ (Delta) is a power increment which can be an integer and/or decimal, such as 1, 1.2, 1.8, 2.1, 3.0, etc. The score, ΣT, Sum-T, will have a high value, near 1.0, if any or all of the individual variable “T-Values” have high values near 1.0, thereby indicating that at least one, and perhaps more, of the variables for that observation have a high likelihood of being normal or typical. The second method, to transform the T-Values, calculates one value, termed the “Sum-T”, which is another approach to calculate the overall score. This technique is a generalized procedure that calculates one value to represent the overall values of a group of numbers or probabilities. It converts, for a set of k numbers, such as probabilities p1, p2, . . . , pk, for example, into a single generalized summary variable that represents the values of these numbers with emphasis on larger probabilistic values. This calculation then isolates the higher T-Value variable values and gives them more emphasis or weight in the calculation. In the fraud detection models, it effectively ranks the overall risk of an outlier variable being present for an individual observation. The Sum-T is the final fraud score and it is defined for control-coefficients φ and δ, as follows:

ΣT_{φ,δ}=[Σ_{t=1,k}ωₜ·Tₜ^{φ+δ}]/[Σ_{t=1,k}ωₜ·Tₜ^{φ}] Sum-T:

Note that phi φ and delta δ do not need to be integers. For this invention the numerator powers are always greater than the denominator powers for the Sum-H function. Smaller φ values emphasize the smaller individual values over the larger ones, and larger φ values emphasize the larger individual values over the smaller. These estimates can then be used to compare the relative performance, or risk, among different geographies and across multiple provider specialties.

The individual T-score value and the individual T-Values corresponding to each variable are then sent from the T-Sigmoid Transformation Module 216 to the Score Reason Generator Module 217 to calculate score reasons for why an observation score as it did. The Score Reason Generator Module 217 is used to explain the most important characterization variables that cause the score to be highest for an individual observation. It selects the characterization variable with the highest T-Value and lists that variable as the number 1 reason why the observation scored high. It then selects the characterization variable with the next highest T-Value and lists that characterization variable as the number 2 reason why the observation scored high, and so on.

A copy of the scored observations is sent from the Score Reason Generator Module 217 to the Score Performance Evaluation Module 218. In the Score Performance Module, the scored distributions and individual observations are examined to verify that the model performs as expected. Observations are ranked by characterization score, and individual claims are examined to ensure that the reasons for scoring match the information on the claim, provider, healthcare merchant or patient. The Score Performance Evaluation Module details how to improve the performance of the Normal Behavior score model given future experience with scored transactions and actual performance on those transactions with regard to normal and abnormal performance. This process uses the Bayesian posterior probability results of the model for the T-Values of the model variables

p[V|T]=p[normal−claim|acceptable−T-Value]

p[V′|T]=1−p[V|T]

p[V|T′]=p[abnormal−claim|unacceptable−T-Value]

p[V′|T′]=1−p[V|T′]

To determine their values calculate the prior conditional and marginal probabilities

p[T|V] p[T|V′] p[V]

These last two conditionals are represented by distributions obtained from Module 224, the Feedback Loop of actual claim outcomes, one for the normal claims and one for the abnormal claims, and p[V] is a single value for the current version of the Feedback Loop in Module 224. These values can be determined directly from summarizing the data obtained from actual results, based on the normal/abnormal determinations. The results would be presented in the form of two relationships—the probability of misclassifying a normal claim and the probability of misclassifying an abnormal claim, based on the selected critical T_{critical} value. The decision rule assumes that a claim is normal unless indicated to be abnormal and is stated as “Assume Claim Normal, then if T>T-boundary assign as abnormal”.

The advantages of the present invention include the following, without limitation.
1. The present invention avoids the rigorous assumptions of parametric statistics and its score is not distorted by the very existence of the objects it is trying to detect, namely outliers that cause data distributions to be misleading. Instead, this technology takes advantage of the homogeneous, stable part of a variable distribution. It uses a special adaptation of nonparametric statistics to convert raw data variable values into normalized values that are then converted to estimates of the likelihood of being a “normal” or “typical” claim, provider, healthcare merchant or beneficiary. These estimates, which are directly comparable to one another and rank “normal behavior” in an orderly monotonic fashion, are then used as variables in the “good behavior” characterization scoring model. The non-parametric statistical tools developed for this patent are robust statistical methods, which avoid the restrictive and limiting assumptions of parametric statistics. These non-parametric statistical techniques are not distorted by outliers and asymmetric non-normal distributions and are therefore robust, stable, accurate and reliable measures of typical, normal or “good” behavior.
2. The “good” behavior characterization model is designed and based on the concept that the majority of the submissions are “normal”, “typical” or “Not Bad” claims, providers, healthcare merchants or beneficiaries similar to statistical hypothesis testing where it is assumed that there is “no statistical difference” until demonstrated otherwise. Characterization variables are created with the objective of describing “good” or “typical” behavior. Historical data is used for score model development. Then, incoming observations are scored based upon the historical data characterization score model data. A plurality of non-parametric statistics are used to build the score models and to describe the data distributions and test them for consistency. Rather than giving more points, on a score type scale, for odd, unusual or “bad” behavior, these “good” score models assign the most points for behavior that is centered about the mid-point of the data distribution under the assumption that providers, claims, beneficiaries and healthcare merchants that are nearest to the “middle” value of other similar providers, claims, beneficiaries and healthcare merchants are “normal” or “not unusual”. Each variable in the “good” characterization model is rescaled into an “intermediate” characterization score so the midpoint value of that variable receives a maximum score and the outer values in the “tails” or ends of the distribution receive a minimum score. As characteristics deviate from the midpoint value, they receive fewer points so that those values that are outliers receive near zero points. These low scoring outliers with their low point values then define the “non-normal” distributional boundaries and identify the opposite of “good”, or “normal”, characteristics. Once all the individual variable's intermediate characterization scores are calculated, a total score is calculated that combines all the individual, intermediate scores into one overall characterization score.
3. Existing healthcare fraud prevention technology uses parametric statistical techniques and generally focuses on detecting or describing the behavior of “bad” or fraudulent claims, providers and beneficiaries. Using current technology, namely Z-Scores and parametric statistical techniques, for example, actually impedes the discovery of unusual, atypical, outlying behavior characteristics. In fact, by adding outliers to a normal distribution, the outliers can have such a significant influence on the mean and standard deviation that the presence of the outliers is masked when calculating Z-Scores, for example, and the statistics yield results that indicate there are no outliers present. Adding outliers to a data distribution and using Z-Score technology in attempt to detect these outliers, actually “appears” to make the outliers “disappear”. Also, there is much to be said in favor of describing the characteristics of a “good claim”, “good provider”, “good healthcare merchant” or “good beneficiary”, rather than a “bad guy”. Generally, “bad guys” are constantly changing patterns and characteristics that might lead to their detection. In fact, the “good” behavior model is easier to verify because it can be assumed a claim is good until indicated bad, similar to statistical hypothesis-testing where it is assumed a state of “NO Difference” exists unless “demonstrated” otherwise. In general, in most cases, “consistent” or “normal” behavior is expected rather than the relatively smaller number of rare, unstable and varied inconsistent or non-normal behavior. Normal behavior is also more stable and predictable and there are a far larger number of typical or “good” claims, providers, healthcare merchants and beneficiaries than there are bad ones. Therefore, more “stable” models are likely to result from using the “normal” patterns rather than the more sparse bad patterns. Fraudulent, abusive and wasteful perpetrators typically change and adapt their behavior to avoid new techniques that are constantly being developed to detect and thwart their illicit behavior. When building the fraud prevention models it is difficult to a-priori design and build models to predict all the different forms of“bad” behavior, and so, by definition, the model builders would have to wait to discover them after the fact. Perpetrators of fraudulent, abusive and wasteful behavior, by their nature, are continually plotting and scheming to find ways to beat the system while remaining anonymous and unpredictable. Thus their behavior characteristics are often transient, inconsistent and difficult to detect, and define. Therefore, fraud models intended to describe this “bad” behavior, behavior that is constantly changing, is like trying to describe a moving target or elusive quarry. Additionally, there are generally a very small number of examples of any one type of “bad” behavior because only about 5% to 10% of all claims, providers or beneficiaries are considered to be “bad”, while the majority, (90-95%) are not fraudulent, abusive or wasteful. This disparity means there is available a much larger, more stable set of data for describing “normal”, “typical” or “good” behavior. The larger pool of more homogeneous data for describing “good” behavior also means there is more likely to be statistical model stability. The final “good” characterization score is a single number that represents the likelihood that this particular provider, claim or beneficiary is “good”, “typical” or “normal”. This single, scalar value is derived by combining the multiple, individual variable scores into one value for each observation.
4. The present invention avoids the rigorous assumptions of parametric statistics and its score is not distorted by the very existence of the objects it is trying to detect, namely outliers, which cause data distributions to be misleading. Instead, this technology takes advantage of the homogeneous, stable part of a variable distribution. It uses a special adaptation of nonparametric statistics to convert raw data variable values into normalized values that are then converted to estimates of the likelihood of being a “normal” or “typical” claim, provider, healthcare merchant or beneficiary. These estimates, which are directly comparable to one another and rank “normal behavior” in an orderly monotonic fashion, are then used as variables in the “good behavior” characterization scoring model. The non-parametric statistical tools developed for this patent are robust statistical methods, which avoid the restrictive and limiting assumptions of parametric statistics. These non-parametric statistical techniques are not distorted by outliers and asymmetric non-normal distributions and are therefore robust, stable, accurate and reliable measures of normal behavior.
5. The “good” behavior characterization model is designed and based on the concept that the majority of the submissions are “normal”, “typical” or “Not Bad” claims, providers, healthcare merchants or beneficiaries similar to statistical hypothesis testing where it is assumed that there is “no statistical difference” until demonstrated otherwise. Characterization variables are created with the objective of describing “good” or “typical” behavior. Historical data is used for score model development. Then, incoming observations are scored based upon the historical data characterization score model data. A plurality of non-parametric statistics are used to build the score models and to describe the data distributions and test them for consistency. Rather than giving more points, on a score type scale, for odd, unusual or “bad” behavior, these “good” score models assign the most points for behavior that is centered about the mid-point of the data distribution under the assumption that providers, claims, healthcare merchants and beneficiaries that are nearest to the “average” value of other similar providers, claims and beneficiaries are “normal” or “not unusual”. Each variable in the “good” characterization model is rescaled into an “intermediate” characterization score so the midpoint value of that variable receives a maximum score and the outer values in the tails of the distribution receive a minimum score. As characteristics deviate from the midpoint value, they receive fewer points so that those values that are outliers receive near zero points. These low scoring outliers with their low point values then define the “non-normal” distributional boundaries and identify the opposite of “good”, or “normal”, characteristics. Once all the individual variable intermediate characterization scores are calculated, a total score is calculated that combines all the individual, intermediate scores into one overall characterization score. It is important to point out that the final characterization score is a single valued function even though it may originate from either the high side of the low side of the distribution.
6. The non-parametric statistical techniques developed and described in the present invention are used to estimate the zero and hundredth percentile values based on the central “mass” of the data distribution, or the distributions “homogeneous” area. It is hypothesized that at least the bulk of a variable's distribution is in this centralized homogeneous central mass of the data distribution. This homogeneous central mass may change in size for each individual variable. The area or amount of the data distribution included in this central mass can be expressed as a percent of the total number of observations for each variable. This central mass area, referred to as Beta (β), may be, for example, 0.80, which represents the most stable 80% of the variable's data distribution. This area is an estimate of the data distribution's homogeneous area for that variable. Choosing an optimal value for the β is important in that it optimizes the tradeoffs between the potential for false-positive and false negative conclusions as well as the potential total percent of estimated “good” or “typical” or “normal” observations. The larger the β, the larger is the probability of more false-negative results in the final score model and the smaller the β, the greater the probability of a false-positive outcomes in the final model. The optimal balance, and thus the specification of β, is often a pragmatic or economic decision, and may not a statistical one. Generally, when the model is validated, a sample of observations are examined in detail and then the model is implemented on a large scale and claims are reviewed to determine if the selected β value met the business objective of optimal balance between false positives and false negatives.
7. Once the β value is determined based on the characteristics of each individual variable's data distribution, non-parametric statistics such as the lower and upper boundaries of the central stable area of the data distribution are calculated for each variable. If, for example, β=0.80, then the lower boundary is the 10^{th} percentile value of that particular variable and the upper boundary is the 90^{th} percentile value of that particular variable. Next, the range of the central stable area is determined and from that, the projected, or estimated, distribution midpoint and the zero and one hundredth percentile values are calculated. None of these statistics are based upon or dependent upon the data distribution's parameters, such as the Mean or the Standard Deviation, both of which are dramatically, negatively influenced by data distribution abnormalities, such as data skew and the presence of data outliers.
8. The next important benefit in the process involves “converting” each observation's raw data variable value, as measured by a “distance”, both positive and negative, from the data distribution's midpoint. This “standardized” positive or negative deviation from the distribution midpoint enables direct comparison among variables in terms of how far the observation's value is from each variable's midpoint, regardless of the scale of measurement of each individual variable. For example, if variable X1 is measured in inches and variable X2 is measured in dollars, it isn't reasonable to compare those values for any two observations. However, it is possible to compare the fact that for observation number one, variable X1, is two “dimensionless” units below the distribution midpoint and for the same observation, variable X2, is 5 “dimensionless” units above the distribution midpoint. This deviation calculation is calculated by subtracting the variable's midpoint value from the raw data value and then dividing this difference by a non-parametric measure of the dispersion of the distribution, for each observation for each variable. The result of this calculation is termed the “G-Value” for a particular, individual variable for each observation in the data. This G-Value can now provide information about where this variable's value for a particular observation lies with respect to the estimated 100^{th} percentile or 0^{th} percentile, for example. If the G-Value for a particular variable for a particular observation is less than the estimated 0^{th} percentile or greater than the estimated 100^{th} percentile, it is an indication that this variable for this observation may be atypical or have an unexpected, non-normal value. G-Values are centered about the distribution mid-point, so a G-Value of “0” means that the variable's value for that observation is located at the mid-point value. G-Values are dimensionless and those below the distribution mid-point are negative and those above the mid-point are positive.
9. In order to better understand non-zero variable G-Values and their likelihood, each observation G-Value is transformed into a Cumulative Distribution Function (CDF) value using a simple sigmoid logistic transfer function. This is done in order to be able to directly compare each variable's relative ranking on a similar scale, the CDF. These sigmoid transformed variables are identified as H-Values, and these H-Values are made a function of g[x]. The H-Values are everywhere positive and they range from 0 to 1 for each variable. The H-Value calculation includes a scaling coefficient, Lambda (λ) that adjusts the H-equation so that when the G-Value is equal to “1”, the H-Value probability is (1+β)/2, and when the G-Value is “−1” the H-value probability is (1−β)/2. The lambda value, λ, is a function only of β, not of the individual variable, X, and so the determination of β (and thus the associated λ) should be made individually for each variable based on the assumption of the scope of homogeneity and shape of that variable's central, stable part of the distribution. It is important to be able to directly compare the relative impact of individual variables so the relative performance of providers, for example, can be compared across specialties and geographies. The benefit of using these non-parametric techniques is that the fraud, abuse and waste prevention and detection rates are maximized and the false positive rate and false negative rates are minimized.
10. For decision-making and variable value inlier identification of the “good-guy” identity, it is desired to have a maximum “good guy” score at the individual variable's distribution midpoint (MP) and have progressively smaller scores away from that MP, in both the positive and negative direction from the MP. To accomplish this maximum value at the midpoint, the G-Values are also transformed into associated T-Values for each individual variable for each observation. The resulting triangular T transformed distribution has a maximum value of 1 at g[x]=0, which occurs when x=MP, and tails away toward zero as absolute value g[x], (|g[x]|), becomes large. The T-Value is a pyramid shaped distribution rather than sigmoid, but tends to follow the distributional shape of the H[g] at the tails. This transformation gives high variable values at the midpoint, which are deemed to be “typical” and low variable values at the extremes, or tails, of the distribution, which are deemed to be atypical or not normal. The benefit for understanding extreme values at the low end of a distribution as well as the high end is that it may be as desirable to determine if a provider is “under” servicing beneficiaries as well as understanding if a provider is “over” servicing beneficiaries or abusing standard, normal medical practices. Or, it might be useful to determine beneficiaries that “under” utilize healthcare facilities as well as those that over-utilize them.
11. Score model files include multiple variables, therefore it is important to know how these variables, as a composite, describe the overall behavior of the claim, provider, healthcare merchant or the beneficiary. Therefore, a “Total Overall Score” is calculated using the information from the individual variable T-Values. The objective of the total score is to describe this overall observational goodness or normalcy for all the variables combined. The total score is a summary statistical measure that allows for meaningful accumulation of all the individual variable T-Values. All of the T-Values associated with each of the individual variables for one observation are combined by “averaging” them into one overall T-Score that represents the likelihood that this particular transaction or observation, provider, claim, beneficiary or healthcare merchant is, overall, “normal” or “a good guy”. This transformation is referred to as the observation's “ΣT-score” (Sigma-T-score or “Sum-T score”). This ΣT calculation accumulates the individual variable T-Scores into a single summary score, where summary values near 1.0 indicate overall homogeneous normal behavior, and scores approaching zero indicate suspicious non-homogeneous, unexpected and atypical behavior (possible outlier). As such the ΣT score is the final fraud, abuse and waste score for an observation. The ΣT score is designed to emphasize the separation between high T-Values, near “1.0” and low T-Values, near “0”. In calculating the ΣT, if the decimal T-values are raised to a power, 2 for instance, in calculating the “combined” T-Values for all the variables for one observation, then the higher decimal values, more “normal” values, will become more separated from the lower decimal values. For example, when calculating IT, if the decimal T-Values are raised to a power, 2 for instance, in calculating the “average” T-Values for all the variables for one observation, then the higher the decimal values, the more likely the values will remain high. As the decimal values become smaller, they will become progressively more separated from the higher decimal values. Thus for example, if all of the variables for one observation have a T-Value of “0.9” and they are squared in the “averaging” calculation, their final score for that observation is “0.81”, or 90% of the original values, which is still relatively close to the mid-point value of “1.0”. In contrast however, if all of the T-Values for a different observation are “0.3” (⅓ of 0.9), for example, and they are squared in the averaging calculation to determine the ΣT score, their ΣT score is “0.09” which is only 1/9^{th} that of the 0.30 original values. This “power function” feature for calculating ΣT gives more displacement-weight to those values that are unusually distant from the expected ΣT value of 1, and less weight to those that are closer to this expected value. The result is that there is greater separation between the lower and higher decimal numbers, when raised to a power greater than 1.0. This decimal power function feature tends to maintain a higher overall total score value for observations with many individual variable T-Values in the high decimal ranges, near the mid-point, and causes low scoring T-Values that are farther from the midpoint to have even lower total score values. In a sense, this feature gives more “weight” to values that are closer to zero and less “downward weight” to those that are nearer 1.0, the desired midpoint. This separation tends to emphasize lower T-Value variables in the total score, a desirable effect when looking for unusual and atypical behavior. In summary, ΣT is a measure of the observation's conformance to the set of expected values for the variables being measured. This separation tends to emphasize lower T-Value variables in the total score, a desirable effect when looking for unusual and atypical behavior.
12. The next step in the score development and evaluation process, and an important benefit, is to create a reason code list that explains why observations scored as they did, based on the component individual variable T-Values. If the objective is to explain why a score was low, the characterization variable associated with the smallest T-Value for that observation's ΣT score is the primary, number one variable, and therefore reason, that contributed negatively (i.e., is the least “normal” or “typical”) to the overall “good-guy” score for the provider, claim, beneficiary or healthcare merchant being scored. The variable with the second smallest T-Value is the next most negative contributor, etc. This risk ranking enables reviewers to focus on the individual variables that caused the unusual behavior and direct prevention and enforcement efforts for that provider, for example, to those negative characteristics.
13. The final step in developing a scoring model is to deploy it in production so it can be used to score a large number of new, incoming transactions. Each of the variables on the incoming claims is converted to a G-value and, ultimately a T-Value that indicates the individual variable's values that express “typical” or “normal” characteristics of this variable. These individual variable estimates are then combined into an overall ΣT score, which is an estimate of the overall degree to which the claim, provider, beneficiary or healthcare merchant associated with that particular observation, or group of variables, is typical and acceptable, i.e., an inlier. The individual T-Value and overall ΣT scores (along with necessary reason codes) are part of the deployed “production environment” which scores new claims, providers, beneficiaries and healthcare merchants on their relative likelihood of being “good” or “typical” or “normal”. If this scoring is done in an Application Service Provider environment, where observations from multiple healthcare organizations can be scored, it provides a more comprehensive base upon which to calculate the non-parametric statistics and data distribution attributes. It also provides a more comprehensive overall view of an individual provider's behavior pattern.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims. Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below (e.g. claim 3 may be taken as alternatively dependent from claim 2; claim 4 may be taken as alternatively dependent on claim 2, or on claim 3; claim 6 may be taken as alternatively dependent from claim 5; etc.).

This completes the description of the preferred and alternate embodiments of the invention. Those skilled in the art may recognize other equivalents to the specific embodiment described herein which equivalents are intended to be encompassed by the claims attached hereto.

What is claimed is:

1. A computer implemented method comprising:
receiving, by a computer, a healthcare observation in healthcare industry relating to: a healthcare claim, a group of healthcare claims, a healthcare provider, a healthcare beneficiary and a healthcare merchant;
receiving a plurality of raw characterization variables related to the healthcare observation, the plurality of raw characterization variables consisting of: health of the healthcare beneficiary, co-morbidity of the healthcare beneficiary, an amount of healthcare effort expended by the healthcare provider, distance from the healthcare provider to the healthcare beneficiary, fee amount submitted for the healthcare claim, sum of all dollars submitted for reimbursement in the healthcare claim, number of procedures in the healthcare claim, number of modifiers in the healthcare claim, change over time for amount submitted in the healthcare claim, a number of the healthcare claims submitted over time, total dollar amount of the healthcare claims submitted over time, comparisons of daily trends for amount billed for the healthcare claim, a time between a date of service and a date of the healthcare claim, a ratio of the healthcare effort required to treat a diagnosis compared to the amount billed on the healthcare claim;
using, by the computer, non-parametric statistical measures to calculate corresponding G-values representing deviations for each of the plurality of raw characterization variables related to the healthcare observation, wherein each of the G-values are calculated by subtracting from each of the raw characterization variables an overall midpoint value of the raw characterization variables further divided by a difference between two percentiles corresponding to each of said raw characterization variables;
transforming, by the computer, each of the G-Values into corresponding T-Values by calculating T=2/(1+e), wherein e represents Euler's number, λ represents a scaling coefficient and g represents each of the corresponding G-Values and;
combining, by the computer, all of the corresponding T-values together into a single scalar value to calculate the inlier identification score to identify fraud, abuse or waste in the healthcare observation, and
sending the inlier identification score to an investigations analysis display so an investigations analyst can further review.

2. The method of claim 1 further comprising:
subtracting a current value of at least one of the raw characterization variables of the healthcare observation, from a historic midpoint value computed for the at least one of the raw characterization variables, and further dividing the result by a Beta value representing a middle percent of a homogeneous, un-skewed distribution for the at least one of the raw characterization variables.

3. The method of claim 2 wherein 100 percentiles are computed from the historic midpoint value for the at least one of the raw characterization variables.

4. The method of claim 3 wherein the Beta value is between zero and one.

5. The method of claim 1 wherein the combining all of the corresponding T-Values together into a single scalar value to calculate the inlier identification score for the observation, further utilizes a geometric mean.

6. The method of claim 1 wherein the combining all of the T-Values together into a single scalar value to calculate the inlier identification score for the observation, further utilizes a summation expressed by:
ΣT_{φ,δ}=[Σ_{t=1,k}ωₜ·Tₜ^{φ+δ}]/[Σ_{t=1,k}ωₜ·Tₜ^{φ}], Sum-T:
wherein ωₜ is a weight variable for Tₜ, φ is a positive integer power value of Tₜ, and δ is a positive power increment value.

7. The method of claim 2 further comprising periodically computing a median point and the Beta value for each of the raw characterization variables from historical data.

8. The method of claim 1 where the inlier identification score is calculated in a batch mode or in real time.

9. The method of claim 1 wherein the weight variable is updated systematically using a nonparametric algorithm.

10. The method of claim 1 wherein the weight variable is updated systematically using a parametric algorithm with feedback loop.

11. The method of claim 1 wherein reason codes are provided to explain the calculated inlier identification score based on a ranking of the corresponding T-values.

12. The method of claim 1 further comprising:
including a plurality of non-binary and binary variables types in calculating the inlier identification score.

13. The method of claim 1 wherein the inlier identification score is calculated using a plurality of external data sources, comprising: credit bureau, and historical healthcare data from past time periods.

14. The method of claim 1 wherein the healthcare industry comprises at least one of: Hospital, Inpatient Facilities, Outpatient Institutions, Physician, Pharmaceutical, Skilled Nursing Facilities, Hospice, and Home Health.

15. The method of claim 1, wherein the healthcare observation and the plurality of raw characterization variables are received from at least one of: Medicare, Medicaid, Tricare, Private Insurance Companies, Third Party Administrators, Medical claims Data Processors, Electronic Clearinghouses, and claims Integrity Organizations that utilize edits or rules and Electronic Payment entities to process and pay the healthcare claims to the healthcare provider.

16. The method of claim 2 wherein the inlier identification score is calculated using both high and low sides of a data distribution for each of the raw characterization variables, from the historic midpoint value for each of the raw characterization variables.

17. The method of claim 1 further comprising:
comparing, using probability scores for each of the plurality of raw characterization variables, performance of the healthcare claims, the healthcare provider, the healthcare merchant, and the healthcare beneficiary across multiple dimensions including a physician specialty and geography.
